(19) United States
(12) Patent Application Publication
(10) Pub. No.: US 2010/0294244 A1
(43) Pub. Date: Nov. 25, 2010

(54) METHOD AND SYSTEM OF CONTINUOUS CONTROL OF THE POSITION OF AN ACTUATOR FOR CHANGING THE COMPRESSION RATIO OF A COMBUSTION ENGINE

(75) Inventors: Gwennael Favennec, Paris (FR); Jacques Obert, Chaville (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: RENAULT S.A.S., BOULOGNE BILLANCOURT (FR)

(21) Appl. No.: 12/303,887

(22) PCT Filed: Apr. 13, 2007
(86) PCT No.: PCT/FR07/51115

§ 371 Date: Jun. 16, 2010

(30) Foreign Application Priority Data
Jun. 7, 2006 (FR) 0605051

(51) Int. Cl. F02B 75/04

(52) U.S. Cl. 123/48 R

(57) ABSTRACT

A control system that allows continuous adjustment of a position of an actuator jack used to change compression rate of a heat engine, with mechanical-type regulation. A source of pressurised fluid is linked to a circuit to allow movement of the jack in two opposing directions. A servo-control device connected to the jack includes a mechanism to distribute fluid to control the position of a mobile element of the jack. A lever articulated with the mobile element of the jack in an initial articulation point includes a second articulation point with a mobile control unit in transfer controlling the distribution mechanism. The lever is able to turn around the initial articulation point via action of a control moving the driver assembly of the lever, connected to a third articulation point at the opposite end.

The present invention relates to the field of combustion engines and in particular proposes a method and a system for continuous control of the position of an actuator that changes the compression ratio of a combustion engine.

The volumetric ratio, or compression ratio, denotes the ratio between the volume of the combustion chamber when the piston is at bottom dead center (BDC) in the cylinder and the volume of the combustion chamber during the combustion phase, with the piston at top dead center (TDC). In order to control and adjust the compression ratio accurately, it is necessary to have continuous control over the position of an actuator that changes the compression ratio. This makes it possible to improve the performance and benefit of such a device. To achieve this, it is of fundamental importance to have a control that is able to master the position of the actuator over its entire travel while at the same time maintaining the desired position in the static phase.

Systems allowing control over the position of a control actuator of a variable cylinder capacity engine are known, for example, from document EP 1 418 322. Servocontrol using hydraulic pumps is controlled by a controller. The system uses closed-loop control entailing a position or angle sensor as close as possible to the point of actuation and looping back through a computer. Problems associated with the bulk and cost of such complex systems which require a high number of sensors in order to guarantee effective adjustment of the compression ratio, limit their use.

Other existing solutions, such as, for example, the one in patent FR 2 763 097, use a control system with a low power servocontrol device. The low power loops associated with actuation by forces disruptive to the engine do, however, give rise to excessively lengthy actuating times and are therefore ill-suited to effective optimization.

There is therefore a need to find a solution that is simple in design, effective, and of smaller bulk, for managing the position of the actuator that changes the compression ratio.

It is an object of the present invention to alleviate some of the disadvantages of the prior art by proposing a control method which allows the position of the actuator that changes the compression ratio of a combustion engine to be adjusted continuously and automatically.

This object is achieved by a method for the continuous control of the position of an actuator that changes the compression ratio of a combustion engine, performed by a control system including an actuator of the cylinder actuator type capable of driving a mechanism that adjusts the position of the combustion pistons of the engine (thus making it possible to adjust the compression ratio), a slaving device for controlling the movement of the cylinder actuator and control means for controlling the slaving device, the method comprising a step whereby the control means control the movement of the cylinder actuator, characterized in that said control step involves:
a step of moving over a first determined distance a point of articulation of a lever connected by another point of articulation to a moving element of the cylinder actuator that projects with respect to a cylinder actuator body; and
a step of injecting a fluid into the cylinder actuator using the fluid distribution means connected to the cylinder actuator so as to generate a step in which the position of the moving element of the cylinder actuator is altered, the injection step being initiated by a control member controlling the distribution means capable of translational movement and secured to the lever by an intermediate point of articulation;
   the control step being followed by a regulating step of the type involving mechanical regulation of the position of the moving element of the cylinder actuator, in which step the lever drives the control member in an orientation consistent with the direction of travel of said position-altering step in order to halt the injection of fluid.

Thus, by virtue of the method according to the invention, it is very advantageously possible to adjust the position of the actuator continuously, with correction of the proportional type and regulation that is naturally present because of the mechanical connection between the slaving device and the actuator.

According to another specific feature, the step whereby the movement of the cylinder actuator is controlled involves the generation of a position datum by an electric stepping motor that drives the movement over said first determined distance of the point of articulation between the lever and a positioning member associated with the electric motor.

According to another particular feature, the fluid injection step is initiated by a step of translational movement of a multi-way mobile circuit part of the distribution means, secured to the control member, said injection step being performed as long as the mobile circuit part is in the continuation of a fixed circuit part of the distribution means that allows two inlets of the cylinder actuator, that are positioned on each side of a region of travel of a piston of the cylinder actuator, to be supplied with fluid.

According to another particular feature, the mechanical-type regulation step is initiated by rotation of the lever about the point of articulation of the lever to the positioning member, this rotation of the lever being driven via the other point of articulation to the moving cylinder actuator element.

According to another particular feature, the mechanical-type regulation step involves a step of translational movement of a multi-way moving circuit part of the distribution means, secured to the control member, said injection step being halted as soon as the moving circuit part becomes offset from a fixed circuit part of the distribution means that allows two inlets of the cylinder actuator, that are positioned on each side of a region of travel of a piston of the cylinder actuator, to be supplied with fluid.

According to another particular feature, the mechanical-type regulation step involves a step of immobilizing the moving cylinder actuator element, in which step a valve belonging to the fluid distribution means completely shuts off the accesses to the cylinder actuator.

An additional object of the present invention is to provide a slaving system that is simple in design and capable, quickly and optimally, of adjusting the position of an actuator that changes the compression ratio.

To this end, the invention relates to a system for the continuous control of the position of an actuator that changes the compression ratio of a combustion engine, comprising an actuator of the cylinder actuator type, capable of translational movement between two ends, to drive a mechanism that adjusts the variation in compression ratio by altering the stroke of at least one piston of the engine, a source of pressurized fluid associated with a circuit to allow the cylinder actuator to move in two opposite directions, a slaving device for controlling the movement of the cylinder actuator and control means for controlling the slaving device, characterized in that the slaving device comprises:
fluid distribution means for controlling the position of a moving cylinder actuator element that projects with respect to a cylinder actuator body; and
a lever articulated to the moving cylinder actuator element at a first point of articulation and comprising a second point of articulation to a control member capable of translational movement for controlling the distribution means;
   the control means that control the slaving device comprising a member capable of translational movement connected to the lever by a third point of articulation further from the first point of articulation than from the second point of articulation.

Thus, the system according to the invention, that requires neither looping back nor a powerfully rated electric actuator, is compact and simple in design.

According to another particular feature, the distribution means comprise:
a fixed circuit part including connections with two respective pipes for supplying fluid to two inlets of the cylinder actuator which are positioned on each side of a region of travel of a piston of the cylinder actuator; and
a multi-way mobile circuit part translationally driven by the control member.

According to another particular feature, the distribution means comprise a three-position and four-way valve or slide valve, two ports being connected to the cylinder actuator and one port being connected to the source of pressurized fluid.

According to another particular feature, the control means comprise an electric stepping motor associated with a positioning member for positioning the third point of articulation of the lever in order to generate a position datum, the positioning member being capable of translational movement between two ends, each corresponding to an end-of-travel position of the moving cylinder actuator element.

Thus, the system according to the invention allows the rating of the electric motor, which does not develop force but is assisted by the hydraulic cylinder actuator, to be chosen with ease.

According to another specific feature, the actuator of the cylinder actuator type is positioned along a first axis parallel to the axis of translational movement of the mobile member of the control means and to an intermediate axis of translational movement of the moving control member of the distribution means.

According to another particular feature, the distance between the first axis and the intermediate axis is greater than the distance between the intermediate axis and the axis of translation of the moving member of the control means.

Other particulars and advantages of the present invention will become more clearly apparent reading the description hereinafter, given with reference to the attached drawings, in which:

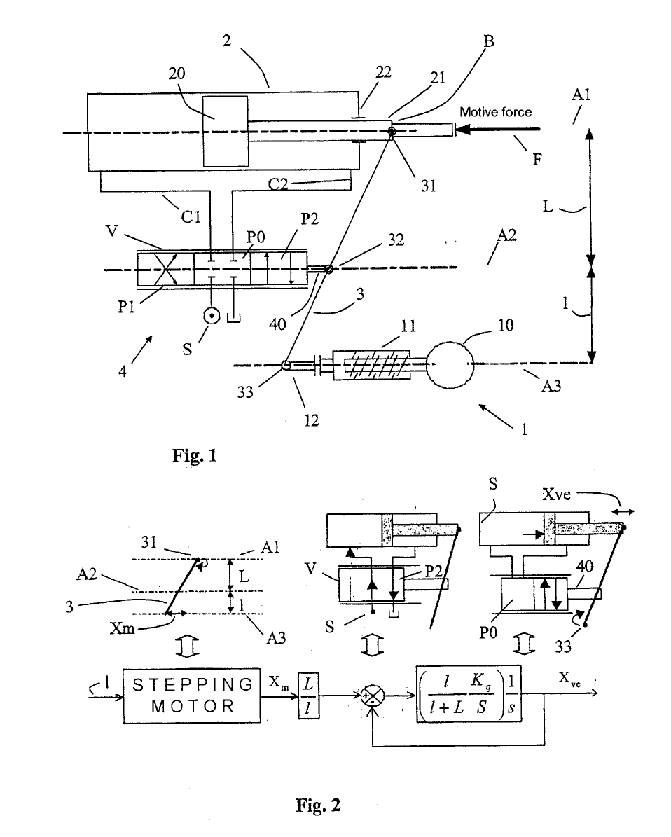

FIG. 1 is an explanatory diagram showing a hydraulic actuator for driving the mechanism that varies the compression ratio, slaving by a method of mechanical regulation of the system according to the invention;

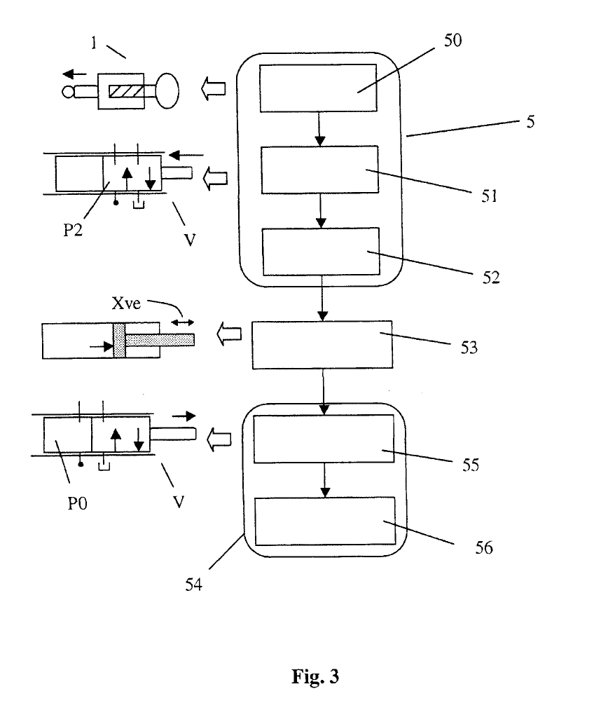

FIG. 2 shows a linear analysis of the operation of a slaving system according to the invention;

FIG. 3 represents a diagram of steps in the method of controlling the position of the actuator according to one embodiment of the invention.

With reference to FIG. 1, the control system allows continuous adjustment of the position of a cylinder actuator (2) that effects the change in compression ratio of a combustion engine, with regulation of the mechanical type. A source of pressurized fluid (S) is associated with a circuit to allow the cylinder actuator (2) to move in two opposite directions. The actuator may thus consist in a single rod dual-actuating hydraulic cylinder actuator (2). By way of nonlimiting example, a system according to the invention can be used to control, for example, the angular portion of an offset shaft which acts mechanically on the variation in compression ratio, as in document EP 1 418 322. A system according to the invention may also control the position of a rack which acts on the variation in compression ratio as in document FR 2 763 097. In one embodiment of the invention one end of the cylinder actuator rod is secured to the mechanism used to adjust the compression ratio. By controlling the movement of such a end of a cylinder actuator rod, it is possible to adjust the variation in compression ratio.

The slaving device (4) associated with the cylinder actuator (2) comprises fluid distribution means (V) for controlling the position of a mobile actuator cylinder element (21) that projects with respect to a cylinder actuator body (22). Control means (1) for positional control are also provided to control the slaving device (4). A mechanical connection established, for example, via a three-articulation lever, allows the moving cylinder actuator element (21), a control member (40) that controls the distribution means (V) and a member (12) that drives the lever (3) of the control means (1) to be connected.

As illustrated in FIG. 1, this lever (3) articulated to the moving cylinder actuator element (21) at a first point of articulation (31) comprises a second point of articulation (32) to the control member (40) capable of translational movement controlling the distribution means (V). The lever (3) can rotate about a first point of articulation (31) through the action of the control means (1) which initiate a movement of the member (12) that drives the lever (3) which is attached at its opposite end to the third point of articulation (33). The third point of articulation (33) is therefore further away from the first point of articulation (31) than from the second point of articulation (32). In one embodiment of the invention, this intermediate second point of articulation (32) supports the control member (40) which drives the translational movement of a multi-way moving circuit part of the distribution means (V). The distribution means (V) comprise a fixed circuit part including connections with two respective pipes (C1, C2) for supplying fluid to two inlets of the cylinder actuator (2) which are positioned on each side of a region of the travel of the piston (20) of the cylinder actuator (2).

The moving circuit part can be moved relative to the fixed circuit part in a translational movement along an axis (A2) of translation of the control member (40). In one embodiment of the invention, the distribution means (V) comprise a three-position (P0, P1, P2), four-way valve or slide valve, two ports being connected to the cylinder actuator (2) and one port being connected to the source of pressurized fluid (S). Thus, the translational movement initiated by a movement of the second point of articulation (32) of the lever (3) provides the switch from one position to another. The distributor may be of the bistable type, controlled by a roller or any other similar control (a push-button, for example).

In order to allow the positioning of the actuating cylinder actuator to be adjusted precisely between two ends, the control means (1) comprise an electric stepping motor (10) associated with a positioning member (11) for positioning the third point of articulation (33) of the lever (3). The electric motor (10) is thus able to generate a position datum. The positioning member (11) is capable of translational movement between two ends each of which may correspond to an end-of-travel position of the moving cylinder actuator element (21). In a preferred embodiment of the invention, the electric stepping motor (10) is a low power motor and associated with a device of the screw-nut type. By way of nonlimiting example, one step may correspond to a movement by 2 mm of the position of the positioning member (11) that positions the third point of articulation (33).

With reference to FIGS. 1 and 2, the control means (1) may initiate a movement over a first determined distance (Xm) of this point of articulation (33) of the lever (3) when an instruction (I) is received from an electronic processing unit that monitors and manages the compression ratio (this unit has not been depicted). The rest position (P0) of the distributor is taken to be an equilibrium position, the actuating cylinder actuator (2) cannot move and the first point of articulation (31) initially forms a pivot about which the lever (3) can rotate when the electric motor (10) initiates movement of the lever (3).

In a preferred embodiment of the invention, the position datum is created via the electric stepping motor (10) on the basis of the instruction (I), each step corresponding to a minimum shift in position. As illustrated in FIG. 1, the distribution means (V) are controlled simultaneously by the electric motor (10) and by the position of the stop (B) formed at the first point of articulation (31) of the lever (3). The lever (3) is therefore made to rotate about the first point of articulation (31). The lever (3) provides mechanical slaving in terms of position. The mechanical connection between the cylinder actuator (2), the distributor (V) and the finger that forms the positioning member (11) of the electric motor (10) may consist in a lever of suitable shape.

In the example of FIG. 1, the lever has no fixed point of reference and moves according to the position of each of the three components it connects. The electric motor (10) dictates as a datum a longitudinal position on its finger moved along the axis (A3) of translation of the third point of articulation (33). This positioning member (11) formed of a finger, via the lever (3), therefore causes the valve to move with a stepdown ratio:

$$\frac{L}{L + l}$$

where L represents the distance (L) between the first axis (A1) of the cylinder actuator (2) and the intermediate axis (A2); and l represents the distance (l) between the intermediate axis (A2) and the third axis (A3) of translation of the moving member (l2) of the control means (1).

Specifically, initially, it must be considered that the position of the first point of articulation (31) is fixed. The lever (3) can therefore be articulated at its connection with the cylinder actuator (3). The aforementioned ratio may range between 0.5 and 0.9 with the intermediate axis (A2) closer to the third axis (A3) than to the first axis (A1). Alternatively, the step-down ratio for movement of the valve may be chosen to be less than 0.5.

Secondly, the movement of the moving circuit part of the distribution means (V) allows access by the fixed circuit fixed part to a position (P1, P2) in which fluid can flow toward the cylinder actuator (2). That means that the cylinder actuator (2) is made to move in the opposite direction to the finger that forms the positioning member (11) of the electric motor (10). The extent (Xve) of the movement of the moving cylinder actuator element (21) is limited insofar as this movement has the effect of re-closing the distribution valve, as illustrated to the right in FIG. 2. A return to the rest position (P0) is initiated by the movement of the moving cylinder actuator element (21). The third point of articulation (33) is then fixed because the electric motor (10) is stopped. In other words, the movement of the moving cylinder actuator element (21) causes additional rotation of the lever (3), the effect of this on the control member (40) of the distribution means (V) being the opposite of the effect had at the time of rotation about the first point of articulation (31).

This opposite effect, which causes the return to the rest position (P0), allows the cylinder actuator (2) to be immobilized quickly enough to avoid overshooting the datum position. The cylinder actuator is immobilized when the valve is completely closed. With reference to FIG. 1, it will also be understood that, if an unwanted force (F) associated with a disruption to the motor shifts the stop (B) of the cylinder actuator (2), the lever (3) will automatically be articulated from its first point of articulation at the positioning member (11) of the electric motor (10). The resulting rotation will have the effect of moving the control member (40) of the distribution means (V) to counter the unwanted movement of the stop (B).

In the latter instance, the corrector thus formed is proportional and its gain is:

$$\frac{l}{L + l}$$

As illustrated in FIG. 2, the system according to the invention can be modeled for the correction, in a simplified way, using a transfer function of the type:

$$( \frac{l}{l + L} \frac{Kq}{S} ) \frac{1}{s}$$

where Kq represents the gain in terms of valve throughput, S represents the cross-sectional area of the cylinder actuator (2) and s corresponds to the Laplace operator. The gain in terms of valve throughput can be written as follows:

$${K}_{4} = \frac{\partial Q}{\partial x} {\vert}_{Δ P}$$

where Q represents a flowrate, x a valve position and ΔP a pressure drop across the hydraulic circuit.

The control system according to the invention naturally is rated appropriately to suit the characteristics of the variable compression ratio engine to which the actuating cylinder actuator (2) is connected. In particular, the cutoff frequency of the corrector thus formed has to be chosen so that it does not cause instability. For a cutoff frequency such as:

$$ω = \frac{1}{τ}$$

The following sizing criterion therefore has to be observed:

$$\underline{\vert \{ \begin{matrix}( \frac{l}{l + L} ) \frac{{K}_{4}}{S} \\ {SP}_{max} \geq {F}_{MaxMoteur}\end{matrix} = τ}$$

where Pₘₐₓ is the maximum working pressure and F_{MaxMoteur} is the maximum disruptive force that the motor can apply (at high levels of pulsation).

The choice of the distances (l, L) between the respective axes (A1, A2, A3) of movement of the articulations (31, 32, 33) of the lever (3) is suited to the type of dynamic range of the motor. Because the correction gain is set once the sizings have been chosen, it will be understood that the sizing has to be correctly chosen from the outset. The dynamics of the opening and closing of the distribution means (V) is in fact dependent on the lengths (l, L) of lever arm with respect to the intermediate axis (A2) and the pass band obtained has to be suited to the dynamic range of the engine, as a person skilled in the art will readily understand.

One example of how positional control according to the invention is had will now be described with reference to FIGS. 1 and 3.

The method for positioning control of the actuating cylinder actuator (2) used to drive the mechanism that adjusts the position of the combustion pistons of the engine involves a control step (5) by the control means (1) controlling a movement of the cylinder actuator (2). To initiate the step (53) whereby the position of the moving cylinder actuator element (21) is altered, this element has to be moved over a certain distance (XVe) in the desired direction. To do that, while the cylinder actuator (2) is immobile, the control step (5) first of all involves a step (50) of movement over a determined distance (Xm) of the point of articulation (33) of the lever (3) at the opposite end to the fixed point of articulation (31) of the lever (2) which is located at the cylinder actuator (2). In the example of FIG. 1, this movement of the third point of articulation (33) is performed via the positioning member (11) associated with the electric motor (10). The method foresees, during the control step (5), the generation of a position datum via the electric stepping motor (10). The electric motor (10) may be a low power motor and the power is amplified between the datum and the amount of movement (Xve) of the actual position of the stop (B) of the moving element (21) of the cylinder actuator (2).

The control step (5) involves a step (52) of injecting fluid into the cylinder actuator (2), in which step the fluid distribution means (V) connected to the cylinder actuator (2) allow the step (53) of altering the position of the moving cylinder actuator element (21) to be performed. The injection step (52) is initiated by the control member (40) controlling the distribution means (V). This control member (40) is, for example, capable of translational movement and is secured to the lever (3) by the intermediate point of articulation (32). In one embodiment of the invention, each point of articulation (31, 32, 33) may be provided with a cam or with a similar mechanical connective element. A step (51) of translational movement of a multi-way moving circuit part of the distribution means (V) secured to the control member (40) controls the fluid injection step (52). This injection step (52) may be performed as long as the moving circuit part is in the continuation of the fixed circuit part of the distribution means (V) so that fluid can be supplied to the two inlets of the cylinder actuator (2). These inlets are positioned on each side of the region of the travel of the piston (20) of the cylinder actuator (2). A valve or slide valve may be used to initiate/halt the injection according to the command provided by the control member (40).

The piston (20) of the cylinder actuator (2) will be moved in one direction or the other along the axis (A1) according to the position (P1 or P2) adopted by the multi-position valve or slide valve. In the nonlimiting embodiment of FIG. 1, the moving cylinder actuator element (21) moves either in a retracting first direction as the positioning member (11) retreats, or in a thrusting second direction as the positioning member (11) extends. In this example, the first active position (P1) of the slide valve corresponds to the first direction of travel, the moving cylinder actuator element (21) is retracted. The second active position (P2) corresponds to the second direction of travel: the moving cylinder actuator element (21) advances and applies thrust to the mechanism that adjusts the position of the combustion pistons of the engine.

As illustrated in FIG. 3, the control step (5) is followed by a regulation step (54) in which there is mechanical regulation of the position of the moving cylinder actuator element (21). The lever (3) drives the control member (40) in an orientation consistent with the direction of travel of the step (53) for altering the position of the cylinder actuator (2). That halts the injection of fluid. This mechanical-type regulation step (54) is initiated by rotation of the lever (3) about the third point of articulation (33). The rotation of the lever (3) is itself driven from the other point of articulation (31) with the moving cylinder actuating element (21) in motion.

During this regulation step (54) the method involves a step (55) in which the multi-way moving circuit part of the distribution means (V) is moved translationally. Thus, the injection step (52) can be halted as soon as the moving circuit part becomes offset from a fixed circuit part of the distribution means (V). The regulating step then ends in a step in which the cylinder actuator element (21) is immobilized, in which step the valve of the fluid distribution means (V) completely closes off the accesses to the cylinder actuator (2). It will be appreciated that this series of steps occurs within a very short space of time, giving the control system good performance.

One of the advantages of the invention is that the control system can be fitted outside of the engine casing, it merely being necessary for a line pressure to be available. Furthermore, the system is able to dispense with electronic control loops.

It should be obvious to those skilled in the art that the present invention can be embodied in numerous other specific forms without departing from the field of application of the invention as claimed.

1-12. (canceled)

13. A method for continuous control of a position of an actuator that changes compression ratio of a combustion engine, performed by a control system including an actuator of cylinder actuator type capable of driving a mechanism that adjusts a position of combustion pistons of the engine, a slaving device that controls movement of the cylinder actuator, and a controller that controls the slaving device, the method comprising:
the controller controlling the movement of the cylinder actuator, comprising:
moving over a first determined distance a point of articulation of a lever connected by another point of articulation to a moving element of the cylinder actuator that projects with respect to a cylinder actuator body; and
injecting a fluid into the cylinder actuator using a fluid distribution mechanism connected to the cylinder actuator so as to generate a position altering in which the position of the moving element of the cylinder actuator is altered, the injecting being initiated by a control member controlling the distribution mechanism capable of translational movement and secured to the lever by an intermediate point of articulation;
the controlling followed by a mechanical regulating the position of the moving element of the cylinder actuator, in which the lever drives the control member in an orientation consistent with the direction of travel of the position-altering to halt the injection of fluid.

14. The method as claimed in claim 13, in which the controlling movement of the cylinder actuator includes generation of a position datum by an electric stepping motor that drives the movement over the first determined distance of the point of articulation between the lever and a positioning member associated with the electric motor.

15. The method as claimed in claim 13, in which the fluid injecting is initiated by a translational movement of a multi-way mobile circuit part of the distribution mechanism, secured to the control member, the injecting being performed as long as the mobile circuit part is in continuation of a fixed circuit part of the distribution mechanism that allows two inlets of the cylinder actuator, that are positioned on each side of a region of travel of a piston of the cylinder actuator, to be supplied with fluid.

16. The method as claimed in claim 14, in which the mechanical regulating is initiated by rotation of the lever about the point of articulation of the lever to the positioning member, the rotation of the lever being driven via the other point of articulation to the moving cylinder actuator element.

17. The method as claimed in claim 13, in which the mechanical regulating includes a translational movement of a multi-way moving circuit part of the distribution mechanism, secured to the control member, the injecting being halted as soon as the moving circuit part becomes offset from a fixed circuit part of the distribution mechanism that allows two inlets of the cylinder actuator, that are positioned on each side of a region of travel of a piston of the cylinder actuator, to be supplied with fluid.

18. The method as claimed in claim 13, in which the mechanical regulating includes immobilizing the moving cylinder actuator element, in which a valve belonging to the fluid distribution mechanism completely shuts off accesses to the cylinder actuator.

19. A system for continuous control of a position of an actuator that changes compression ratio of a combustion engine, comprising:
an actuator of cylinder actuator type, capable of translational movement between two ends, to drive a mechanism that adjusts variation in compression ratio by altering a stroke of at least one piston of the engine;
a source of pressurized fluid associated with a circuit to allow the cylinder actuator to move in two opposite directions;
a slaving device that controls movement of the cylinder actuator; and
a controller that controls the slaving device,
the slaving device comprising:
a fluid distribution mechanism that controls the position of a moving cylinder actuator element that projects with respect to a cylinder actuator body; and
a lever articulated to the moving cylinder actuator element at a first point of articulation and comprising a second point of articulation to a control member capable of translational movement for controlling the distribution mechanism;
the controller means that controls the slaving device comprising a member capable of translational movement connected to the lever by a third point of articulation further from the first point of articulation than from the second point of articulation.

20. The system as claimed in claim 19, in which the distribution mechanism comprises:
a fixed circuit part including connections with two respective pipes for supplying fluid to two inlets of the cylinder actuator that are positioned on each side of a region of travel of a piston of the cylinder actuator; and
a multi-way mobile circuit part translationally driven by the control member.

21. The system as claimed in claim 19, in which the distribution mechanisms comprises a three-position, four-way valve or slide valve, two ports being connected to the cylinder actuator and one port being connected to the source of pressurized fluid.

22. The system as claimed in claim 19, in which the control mechanism comprises an electric stepping motor associated with a positioning member for positioning the third point of articulation of the lever to generate a position datum, the positioning member capable of translational movement between two ends, each corresponding to an end-of-travel position of the moving cylinder actuator element.

23. The system as claimed in claim 19, in which the actuator of the cylinder actuator type is positioned along a first axis parallel to the axis of translational movement of the mobile member of the controller and to an intermediate axis of translational movement of the moving control member of the distribution mechanism.

24. The system as claimed in claim 22, in which the distance between the first axis and the intermediate axis is greater than the distance between the intermediate axis and the axis of translation of the moving member of the controller.
